(19) United States
(12) Patent Application Publication
(10) Pub. No.: US 2005/0162279 A1
(43) Pub. Date: Jul. 28, 2005

(54) Terrestrial crittercam system

(76) Inventors: Gregory John Marshall, Alexandria, VA (US); Mehdi Bakhtiari, Vienna, VA (US); David John Rasch, Taroona (AU)

Correspondence Address: MORRISON & FOERSTER LLP, 1650 TYSONS BOULEVARD, SUITE 300, MCLEAN, VA, 22102, US

(21) Appl. No.: 10/892,381

(22) Filed: Jul. 16, 2004

Related U.S. Application Data
(60) Provisional application No. 60/487,260, filed on Jul. 16, 2003.

(51) Int. Cl. G08B 23/00

(52) U.S. Cl. 340/573.2

(57) ABSTRACT

A method and apparatus for remotely monitoring wild animals in their natural habitat, having a remote monitoring device that is attached to a subject animal, the remote monitoring device having various components such as a video camera, a temperature sensor, a microphone, and a transmitter to wirelessly transmit gathered data to a base station to give scientists a better way to observe the subject animals' behavior in its natural environment with minimal human disturbance.

### CROSS-REFERENCE TO RELATED APPLICATIONS

This application claims the benefit of U.S. Provisional Application No. 60/487,260, filed Jul. 16, 2003, which is hereby incorporated by reference in its entirety.

### BACKGROUND OF THE INVENTION

This application generally relates to a system and method for monitoring wild animals in their natural habitat. Current knowledge of wild animal behavior has been distilled from centuries of dedicated and painstaking observation. Behavioral studies in the wild are often difficult and complicated: subject animals are moving targets, they hide in forests or underbrush, and many are active only at night. For centuries, biologists have sought ways to get closer to their subjects without influencing the behaviors they aim to study, and they have sought ways to maintain contact when their subjects melt into the dark corners of the animal world, out of human sight.

The challenges of studying free-ranging animals in the wild are considerable, in part due to extreme temperatures, high humidity, low visibility, and other factors related to climate and geography that are often encountered. Additionally, many animals have evolved extraordinary sensory capabilities that keep them keenly attuned to the slightest disturbance to the natural equilibrium. In order to observe and understand animals in their natural state, scientists need to get close to them. But the closer scientists get, the more they are likely to influence and affect the behavior under study. The scent of a human being, the rustling pages of a notebook, or the sound of a voice whispering into a tape recorder can easily affect an animal's attention and actions, thereby affecting the integrity of the research into the animal's behavior.

Over the last three decades, technology has stepped in to help biologists overcome some of these restraints. Small radio and satellite transmission systems have been used to help keep researchers connected to their subjects from a distance. Radio collars and satellite transmitters have been deployed on a wide variety of animals to study their movement patterns, free of human influence. Research has shown that subject animals can carry telemetry packages with virtually no impact on natural behavior. They quickly acclimate to a tag or collar and return to their normal behaviors. Deployed on free-ranging animals, these instruments relay information on location and movement patterns in the wild. This work has yielded valuable data on home ranges, migratory routes, and temporal activity patterns. However, these devices cannot tell biologists what an animal is actually doing at a given location and time. While current collar-tags provide invaluable information on animal location and range, the details of animal behavior all too often must still be inferred from blips on a telemetry grid.

A system that is capable of broadcasting live images from an animal's perspective would provide real-time data on habitat use, foraging strategies, social interactions, and the myriad nuances of life that could help to elucidate a more complete and compelling record of the forces that shape behavioral ecology. Scientists would be able to see and measure how species allocate time and why. Biologists would be able to catch more than just a glimpse of the world they are studying. A permanent audio/video record could be made of events, enabling scientists to review animal behavior by systematically, or even statistically, scrutinizing events—frame-by-frame, if necessary—to achieve a new appreciation and understanding of wild animal biology and behavior.

The captured images could also be instrumental in efforts to share the stories of the animal kingdom with the public. By putting audiences in the place of an endangered animal, viewing its life literally “over its shoulder”, scientists and conversationalists would gain a powerful tool to educate and engender concern for the animal's welfare.

A small, light, and efficient video telemetry package to transmit high quality video, audio, and data over considerable distances for extended periods of time harnessed to a study animal could provide a live, uninterrupted data-stream from an animal's point of view, free of disturbing human influences. Such remote observation data would allow biologists, for the first time, to address basic biological questions relating to a species' behavioral ecology. Learning how an animal behaves in its environment allows us to understand its needs, and thus helps scientists to develop tools to protect and conserve wild animals and their habitats.

### SUMMARY OF THE INVENTION

The present invention relates to a system that is capable of remotely monitoring and transmitting data from a wild animal in its natural habitat. The system is secured to the subject animal with a securing device. Various types of securing devices can be used, some examples of which include collars, harnesses, and other devices capable of being secured to a wild animal. The securing devices should be designed for each animal, or type of animal, to be monitored. Some design considerations include habitat, size of the animal, the amount of weight that an animal can carry without significantly affecting its mobility or habits, typical animal activity, and the like. The securing device can have a release mechanism that allows for automatic and/or remote release of the securing device from the animal. A transceiver in the securing device can be used to achieve a remote release of the device. A data acquisition unit is attached to the securing device and is configured to collect audio, video, and/or telemetry data. A data transmission unit for receiving data from the data acquisition unit and transmitting the data is also attached to the securing device, along with a battery for providing power to at least the data acquisition unit and data transmission unit.

The securing device used in the present invention may use a remote release hinge that can be triggered using a transceiver attached to the securing device such that when the transceiver is activated the hinge is released.

According to an aspect of the present invention, the data transmission unit transmits a signal at a frequency of about 450 mhz. By transmitting at this frequency, the data transmission unit is power efficient while maintaining a desirable range.

It is preferable in some cases to have the data acquisition unit and the battery pack located at opposite sides of the securing device to allow for the device to be effectively situated on the animal. As an example, if the securing device is a collar, the battery may be heavier than the data acquisition unit to allow the collar to automatically rotate so that the data acquisition unit is at the highest point.

A receiver may be positioned to receive transmissions from the data transmission unit. If it is desirable to locate the receiver such that it is out of the effective range of the data transmission unit, at least one repeater can be used to receive and retransmit a signal from the data transmission unit.

### BRIEF DESCRIPTION OF THE DRAWING FIGURES

FIG. 1 shows an example of a collar hinge with a remote release mechanism according to an embodiment of the present invention;

FIG. 2 shows an example of a cross section of a battery pack according to an embodiment of the present invention;

FIG. 3 shows a block diagram of an example of a controller board according to an embodiment of the present invention;

FIG. 4 shows an example of a system in which there is direct analog communication from a remote monitoring device to a receiving station according to an embodiment of the present invention;

FIG. 5 shows an example of a system in which multiple analog repeaters are positioned to transmit analog communications from a remote monitoring device to a receiving station according to an embodiment of the present invention;

FIG. 6 shows an example of a system in which multiple analog ground repeaters transmit analog communications from a remote monitoring device to a remote repeater which transmits the communications to a receiving station according to an embodiment of the present invention;

FIG. 7 shows an example of a system in which multiple analog ground repeaters, each having a wireless transceiver, are positioned with overlapping reception areas such that the ground repeater receiving the strongest signal from a remote monitoring device transmits data from the remote monitoring device to a remote repeater which transmits the data to a receiving station according to an embodiment of the present invention;

FIG. 8 shows an example of a system similar to that shown if FIG. 7 wherein the ground repeaters and the remote repeater digitally transmit communications from the remote monitoring device according to an embodiment of the present invention;

FIG. 9 shows an example of a system in which a wireless LAN is used to transmit communications from a remote monitoring device to a receiving station according to an embodiment of the present invention;

FIG. 10 shows a block diagram of an example of a ground repeater according to an embodiment of the present invention;

### DETAILED DESCRIPTION OF THE INVENTION

The present invention includes a remote monitoring device that is capable of recording video, audio, temperature, and other data relating to a subject animal and how the animal behaves in its natural environment, free of human influences. The remote monitoring device is contained in a harness or collar that is attached to the subject animal, preferably when the animal is sedated. The remote monitoring device can contain a small video camera, digital and/or analog, a microphone, a modulator, a transmitter, and/or an antenna. The device is designed to be modularly upgradeable such that it may include various other data gathering devices depending on the parameters that the user wishes to measure or track, and is not limited by the few examples of devices discussed herein. Some examples of data to be gathered include, but are by not limited to: temperature, humidity, light level, and real-time geo-location (by integration of a miniature GPS receiver) which will help provide a comprehensive picture of the subject animal's interactions with its world.

One of the key components of the remote monitoring device is its ability to transmit data to a remote location. Determining a proper transmission frequency is important to the functionality of the remote monitoring device. Telemetered video signals need to travel long distances, penetrate through rough terrain, and provide data over extended periods of time without harming the subject animal. According to an embodiment of the present invention, the remote monitoring device transmits in the 450 MHz range, which is a good compromise of the primary objectives and constraints—animal safety, power budget, signal penetration, and transmission range. For particular animals in specific habitats, the system can be adapted to use higher or lower frequencies in order to obtain the best possible remote observation capabilities according to alternate embodiments of the invention.

The harness or collar that carries the remote monitoring device is carefully designed to accommodate the size and activity of the subject animal to be monitored. For example, an embodiment of the present invention may include a large rugged collar to be worn by a bear around its neck, while in another embodiment a small rodent may be equipped with a harness that will not easily become detached from the animal.

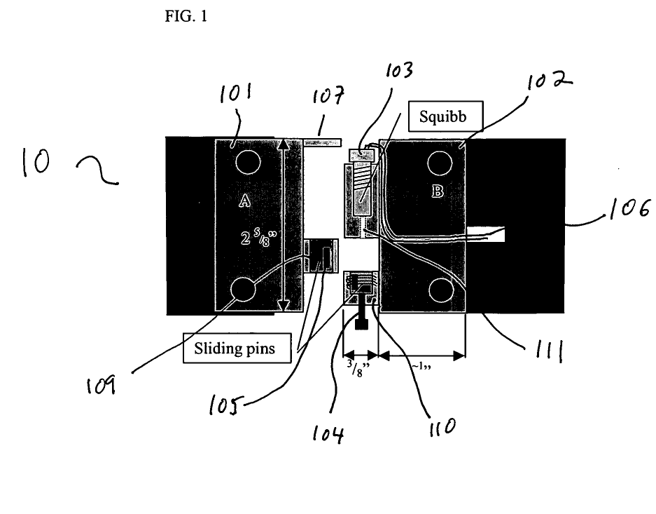

FIG. 1 shows an example of a collar hinge 10 with a remote release mechanism according to an embodiment of the present invention. It is important that a remote monitoring device is able to be removed from the subject animal with as little impact on the animal as is possible. It is also important that the device can be removed quickly if the animal is somehow endangered by the device. While this remote release mechanism is described in relation to a collar, it is equally applicable to a harness or other apparatus used to secure the remote monitoring device to a subject animal. While the collar hinge 10 shown in FIG. 1 has a first hinged plate 101 and a second hinged plate 102, there is no limit to the number of hinge plates that can be accommodated in various embodiments of the present invention. A two plate hinge is shown for simplification.

The first hinge plate 101 has a metal cap 107 at the top to protect the squibb wiring 106 when the hinge plates 101, 102 are joined together. The first hinge plate 101 also has a short hinge tube 108, shown as mounted offset from the center of the first hinge plate 101, having an internal sliding pin 105. The internal sliding pin 105 is approximately the same length as the short hinge tube 108. The second hinge plate 102 has a squibb hinge tube 109 and a spring loaded hinge tube 110 positioned such that the distance between the squibb hinge tube 109 and the spring loaded hinge tube 110 is slightly greater than the length of the short hinge tube 105. While FIG. 1 shows three hinge tubes, alternate embodiments of the present invention can use varying numbers of hinge tubes.

The second hinge plate 102 has a squibb 103 threaded into the squibb hinge tube 109 and a captured spring-loaded pin is in the spring loaded hinge tube 110. Both the internal sliding pin 105 and the spring loaded sliding pin 104 have a groove along part of their lengths. Small set screws are then used to prevent the pins 105, 104 from being separated from their respective tubes 108, 110.

When first hinge plate 101 and the second hinge plate 102 are joined, the spring-loaded pin 104 presses against the internal sliding pin 105, forcing the internal sliding pin 105 partially into the squibb hinge tube 109 and the spring loaded pin 104 partially into the short hinge tube 108. This misalignment of the pins 105, 104 holds the hinge together.

To connect the hinge plates 101, 102, the spring loaded hinge pin 104 has a short bolt protruding from the spring loaded hinge tube that can be pulled against the spring force, temporarily aligning the pins 105, 104 with the hinge tubes 110, 109, 108. Once the hinge plates 101, 102 are aligned, the bolt can be released, and the hinge plates 101, 102 are secured together.

When a predetermined voltage is applied across the squibb's actuating wires 106, a small explosive charge is ignited which forces a steel pin a predetermined distance towards the internal sliding pin 105. The internal sliding pin 105 and the spring loaded pin 104 are then forced back into their respective hinge tubes 108, 110. The dimensions of the steel pin, the internal sliding pin 105, and the spring loaded pin 104 pin are such that when the explosive charge is ignited, the pins and the hinge tubes are aligned, and the hinge plates separate. The voltage can be selectively applied to the squibb's actuating wires based on such inputs as an external signal or a timing device, or various inputs based on other criteria, examples of which include distance from a receiving station or low battery power. Inputs may be based on various other criteria and are not intended to be limited by the examples given. While the explosive charge moves a steel pin in this embodiment, the pin can be made of any material capable of withstanding the forces applied thereto.

While this embodiment of the present invention uses a small explosive charge, other ways of forcing the steel pin can be used. Some examples of alternate ways of forcing the steel pin may include magnetic locks or even compressed gas. Various other ways of forcing the steel pin are also acceptable, however enough force needs to be applied to the steel pin so that the pins and the hinge tubes are aligned, thus separating the hinge plates.

When the collar is correctly oriented on the animal according to an embodiment of the present invention, the release mechanism is on the side of the neck, approximately half way between the battery pack and the Camera Unit. Once released, the weight of the battery pack separates the two hinge plates 101, 102 of the release mechanism, swinging the battery pack downward and drawing the collar off the animal and onto the ground.

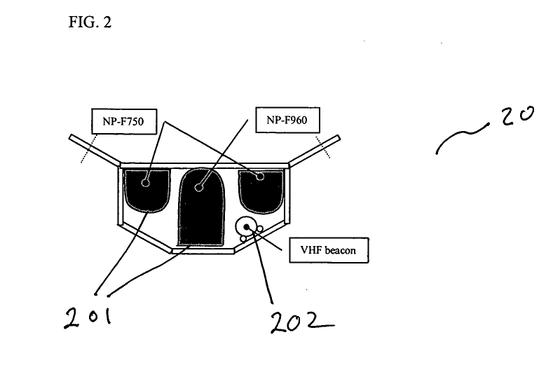

FIG. 2 shows an example of a battery pack 20 designed to power the remote monitoring device. In this aspect of the present invention, the battery pack 20 is constructed from welded aluminum sheet, coated with a rubber coating, such as Flexane, to provide a subject animal some protection from the metal edges, and also to reduce visual distraction to the subject animal or to other animals with which it might be interacting.

The battery pack 20, according to this embodiment of the present invention, is a welded half-hexagon shaped enclosure with a single access hatch on the rear face (towards the back of the animal). The dimensions of the access hatch allow insertion of the batteries 201. In one embodiment of the present invention, two NP-F750 (21.6 Wh), and one NP-F960 (38.8 Wh) type batteries are used. These batteries 201 have a specified voltage of 7.2V, but the fully charged voltage measures closer to 8.3V. The total capacity of the battery pack 20 with these batteries 201 is rated at 82 Wh or around 10,000 mAh.

A power cable, not shown, is attached to the battery pack 20 from the upper (collar) side of the remote monitoring device through a seal to connect to the controller board 30.

The battery pack 20 also contains a VHF telemetry beacon 202 which is preferably kept switched off during storage. In one embodiment of the present invention, the telemetry beacon 202 is kept switched off using a magnet taped to the outside of the battery pack 20. An alternate embodiment of the present invention incorporates a magnetic switch to allow battery pack 20 loading and sealing prior to deployment.

In an embodiment of the present invention, the weight of the battery pack is designed to exceed that of the Camera Unit so that the collar will tend to rotate on the neck of the animal until the Camera Unit is at the highest point.

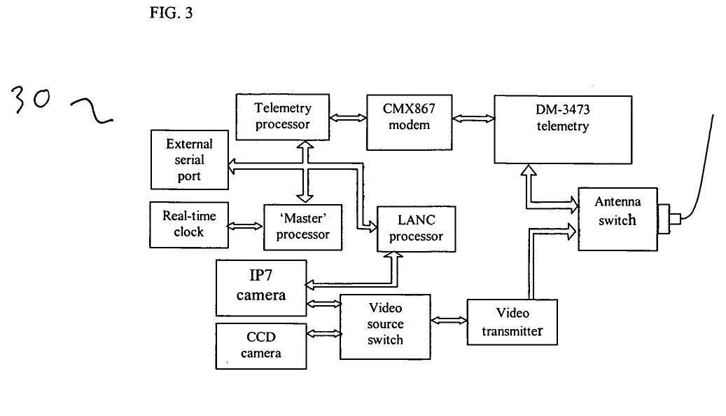

FIG. 3 shows an example of a controller board 30. This system-brain allows flexibility in remote control of the remote monitoring device while providing environmental data logging capability. The controller can be controlled wirelessly to drive the components of remote monitoring device by controlling various actions, examples of which include but are not limited to: camera on/off, pan/tilt/zoom, transmit power, audio level, lens wiper, IR “headlight” activation, visible locator lamp, and remote release. Wireless feedback to the base station may include information such as battery level, transmitter power, subject motion, command acknowledge, locator beacon signal, and/or other information the used desires. The microprocessor allows selective monitoring based on characteristics such as subject motion, ambient light, and/or pre-set intervals, etc. The remote release and beacon activation can be programmed to occur automatically once battery levels become low.

The controller board 30 according to this embodiment of the present invention is a 4-layer printed circuit board. Physically, it has been designed with the same dimensions as a telemetry board, and plugs directly into the telemetry board in two places (MMCX RF connector and 18-pin control port). It also has holes in the same locations as the telemetry board to assist with mechanical mounting.

Connections to/from the controller board 30 are via through-hole pads around the perimeter of the board. In an alternate embodiment of the present invention, PCB posts are used here to allow multiple re-connection operations.

The controller board 30 is quite complex and can be designed to control a multitude of sensors and devices that may be incorporated into various embodiments of the present invention. The controller board 30 shown in FIG. 3 is configured for the following:
1. Mission start/stop and MAX6901 real-time clock support functions.
2. Measurement from up to 4 preset-gain analogue sensors, 1 PWM sensor and 1 digital sensor
3. Sony LANC command and ‘Mode’ (Camera or VCR) control of a camera, such as an IP7
4. Time-scheduling of telemetry ‘Listen for Incoming Command’ operations
5. Incoming command buffering, execution and reply
6. Runtime configuration of a modem chip and a telemetry transceiver for correct operation.
7. Serial communications between main, telemetry, and LANC microcontrollers (there are 3 processors on the controller board shown)
8. Activation of collar release and headlights
9. Video input selection to a video transmitter (in the embodiment shown 3 video sources can be managed, including a feed from the camera)
10. Control of an RF switch to allow sharing of the whip antenna between the video transmitter and telemetry functions
11. Power management of various sections of the circuit board to reduce standby current consumption.
12. Support for direct serial cable commands
13. In-circuit reprogramming of all 3 microprocessors

An alternate embodiment of the present invention contains a battery backup for a real-time clock.

There are three microprocessors located on the controller board 30 of the illustrated embodiment. A ‘Master’ processor, such as a PIC16F877, controls most activities. The other two processors (LANC controller and Telemetry controller) are ‘Slave’ devices, and can be processors such as a PIC16F628. Power needs to be applied to these processors only when an action is required from them.

The three microprocessors share a common communications bus (Serial from Master, Serial from Slave, ground). Slave processors listen for commands on the ‘Serial from Master’ line (diode-blocked to allow processor power-down) and respond to those commands that are addressed to that particular processor by pulling low the ‘Serial from Slave’ line using an open-collector connection. All three processors use their in-built hardware, such as a serial UART, for two-way communications.

An alternate embodiment of the present invention includes an external serial port connection attached directly to the controller board 30 using a short three-wire cable and connector. This connection (made via an interface IC such as an MAX3226 RS232) taps into the shared communications bus. Note that the external serial connection is considered a ‘Slave’ device even though it is issuing commands, therefore any command addressed to one of the other two ‘Slave’ processors must be sent to the ‘Master’ which then re-broadcasts the command on the ‘Serial from Master’ line. Therefore all ‘Slave’ devices as well as the external connection will see commands forwarded by the ‘Master’ to all other ‘Slave’ processors. Each ‘Slave’ checks the address character at the start of each command and only buffers and responds to those commands which are appropriately addressed to that device.

In the present embodiment, when power is first applied to the controller board 30, it issues a LANC command to the camera to power-down into standby mode to conserve battery power.

According to a further embodiment of the present invention, an LED blinks on and off during normal idle operation. When the LED is on, it means the controller board is listening for an incoming command, either from a direct serial cable connection or via telemetry. In this embodiment, the controller board 30 is designed to detect whether an external serial cable has been connected. When the LED is off, the controller board 30 is placed in a reduced power, or ‘Sleep’, mode for battery conservation. Once a command has been received, the LED will stay on for an additional time to allow further command/reply operations to take place immediately.

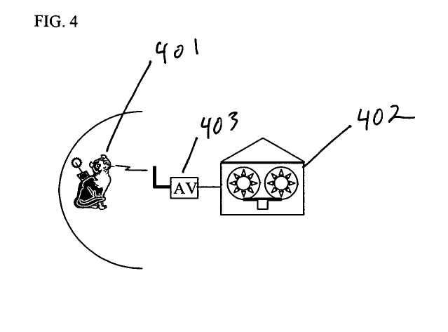

Once the remote monitoring device is attached to a subject animal, the task becomes to put a system in place to receive communication transmissions from the remote monitoring device while remaining far enough away from the subject animal so as not to effect its natural behavior. FIGS. 4 through 9 show examples of various embodiments of the present invention detailing systems for receiving data from remote monitoring units.

FIG. 4 shows an example of a system using direct reception of analog transmissions from a remote monitoring device 401. In this embodiment, the remote monitoring device 401 is shown to be within the receiving range of an analog receiver 403 at the base station 402. The data is recorded at the base station 402. In this system, the physical location of the base station 402 is important. The base station 402 should be located at a position, such as the top of a mountain, to maximize reception area. In another embodiment, the base station 402 is mobile, thereby providing the operator the ability to track a far ranging subject animal as it moves, without having to deploy a remote monitoring device with a large transmission range, or using multiple base stations 402 or repeaters. In the embodiment shown in FIG. 4, the range of the transmitter of the remote monitoring device limits the coverage of the base station 402. The transmitter must be supplied with sufficient power to provide good quality signals (good signal-to-noise ratio), and hence bulky batteries might be needed. To reduce this need for large batteries, an alternative embodiment of the present invention uses the subject animal's movements to generate electrical power.

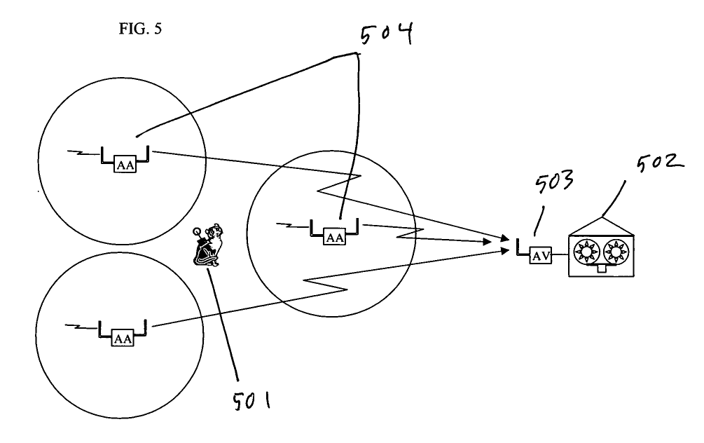

FIG. 5 shows an example of a system having multiple analogue repeaters 504, also referred to herein as ground repeaters 504 without limiting the location of their deployment. In this embodiment, ground repeaters 504 are used to receive the data transmissions from the remote monitoring device 501 and then transmit the data to the base station 502. By using multiple ground repeaters 504, the signal strength of the transmitter of the remote monitoring device can be decreased, thus allowing for a smaller transmitter and power supply. In one embodiment of the present invention, the ground repeaters 504 have a transmitter power of several watts. When multiple ground repeaters 504 are deployed, the base station 502 should be operated at a location where its receiver 503 can receive signals from all of the ground repeaters 504. The ground repeaters 504 should be placed far enough apart so that only one transmitter is active, i.e. transmitting data, at any one time. This is achieved in part by having the ground repeaters 504 switch ON only when the signal strength of the received transmission signal exceeds a set threshold.

In this embodiment, it is possible that due to the spacing of the ground repeaters 504 there may be locations where there is no coverage, thereby leaving blackout zones where data from the remote monitoring device 501 will not be received. The coverage areas are shown in FIGS. 4-9 as circles surrounding the ground repeaters. Blackout areas can be minimized by careful deployment of the ground repeaters 504.

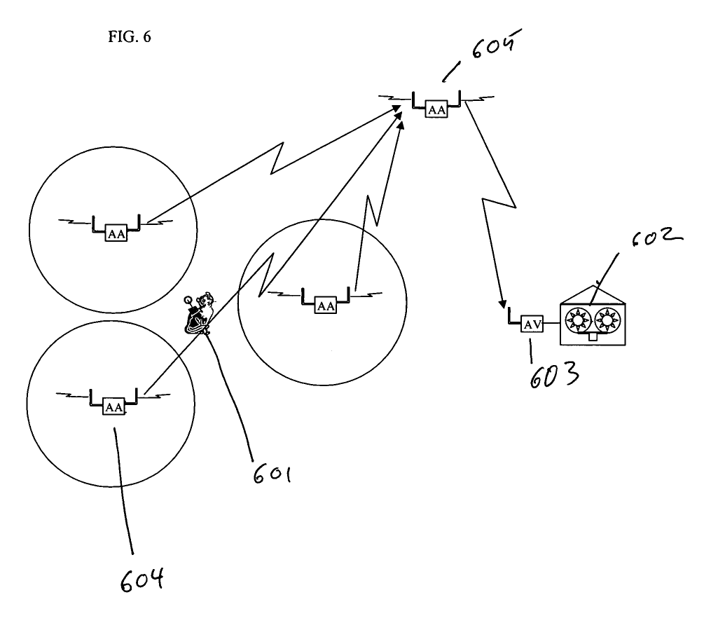

FIG. 6 shows an example of a system using multiple ground repeaters 604 and a remote repeater 605 to transmit data from the remote monitoring device 601 through the base station receiver 603 to the base station 602. This embodiment is similar to that shown in FIG. 5, however, the addition of the remote repeater 605 allows the base station 602 to be positioned at a convenient location without compromising reception. This may be helpful if the subject animal's habitat is in a rugged or otherwise unhospitable location. Also, the power required at the ground repeaters 604 can be reduced by placing the remote repeater 605 in a location central to the subject animal's habitat. While placing a manned base station could negate the benefits of remote monitoring by placing a human presence into the subject animal's enviroment, the placing of the remote repeater should have no effect.

The remote repeater 605 prefferably has a robust power supply and therefore a powerful signal that can reach a remote base station 602 without compramising data integrity. In one embodiment of the present invention, the remote repeater 605 transmits a signal with a power of 10 watts to maintain good data (good signal-to-noise) over an extended distance to the base station 602.

By locating the remote repeater in an optimal position, the transmission power requirements of the ground repeaters 604 is lowered. The transmitter power of the ground repeaters 604 can be further reduced to by placing them in line-of-sight communications with the remote repeater 605. In one embodiment of the present invention, the transmission power of the ground repeaters 604 is reduced below 1 watt by placing them in line-of-sight with the remote repeater 605. In another embodiment, the transmisson power is even further reduced by using highly directional antennas at the repeaters 604, 605.

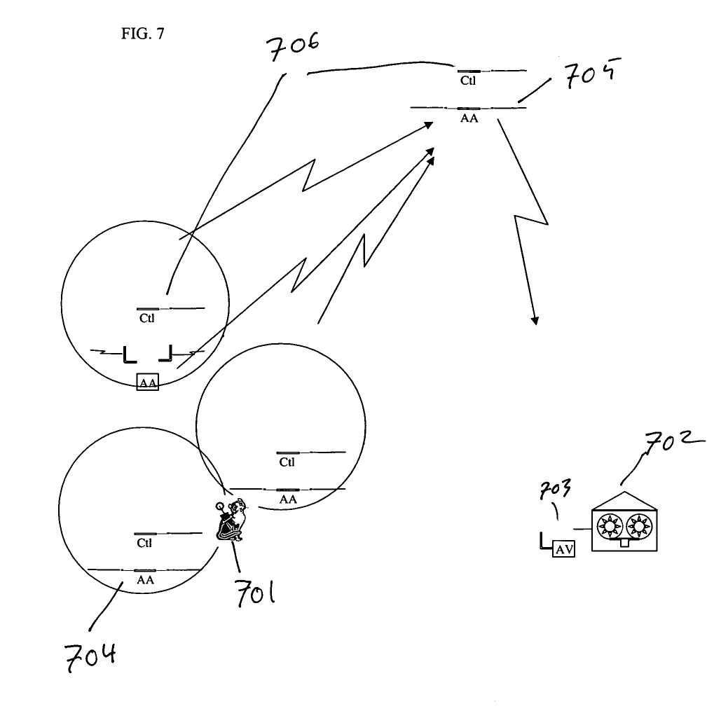

FIG. 7 shows an example of an embodiment having ground repeaters 704 with overlapping reception areas. The base station 702 is shown having a receiver 703. This embodiment is similar to the example shown in FIG. 6, however, the risk of having blackout areas where the signal from the remote monitoring device 701 is lost is eliminated. In this embodiment, the ground repeaters 704 are placed close enough together so that several receivers can simultaneously receive good-strength transmissions from the remote monitoring device 701. However, only one of the repeaters is enabled for transmitting. This is accomplished by providing each of the ground repeaters 704 and the remote repeater 705 with control units having a wireless transceiver 706 to transmit and/or receive various data such as signal-strength information and control signals. The control units 706 of the ground repeaters 704 send signal strength data to the control unit 706 of the remote repeater 705 which then sends a unique command to the ground repeater 704 having the best signal, and thereby enables only that ground repeater 704 to transmit data. Signal strength information is sent regularly from each of the ‘active’ ground repeaters' control units 706, to allow rapid ‘handover’ from one ground repeater 704 to another as the subject animal moves.

In an alternate embodiment of the present invention, a number of control units 706 are located at the remote repeater 705, rather than just one as shown in FIG. 7. Alternately, if the control units 706 have an area of reception large enough to include all the ground repeaters 704 the control unit 706 that controls the ground repeaters 704 might be attached to one of the ground repeaters 704, such that the ground repeaters 704 are identical units, yet one is configured to be the “Master Control unit” and the others are slaves.

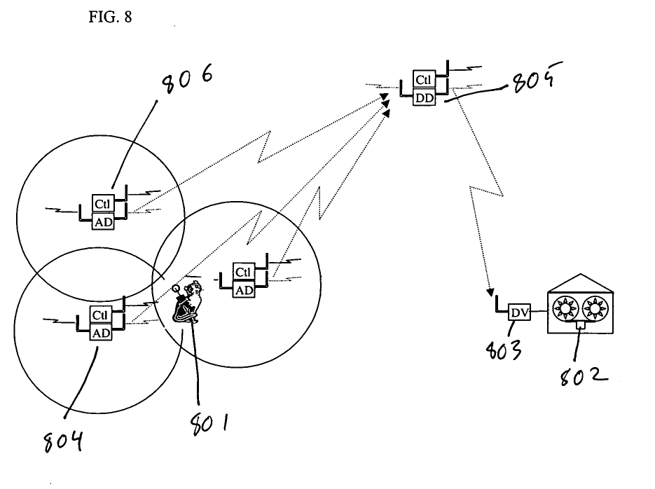

FIG. 8 shows an example of a system similar to that shown in FIG. 7, where data is transmitted from a remote monitoring device 801 to a base station 802 having a receiver 803. However, in the embodiment shown in FIG. 8 each ground repeater 804 contains an A/D converter to digitize received analog video signals and to transmit the digital video signal as a high-speed data stream. By transmitting the signal digitally, degradation in signal quality due to transmission is reduced and the user is provided with more acurate data and better video quality. Control units 806 are used to decide which ground repeater 804 is to transmit, based on unique commands from the remote repeater 805.

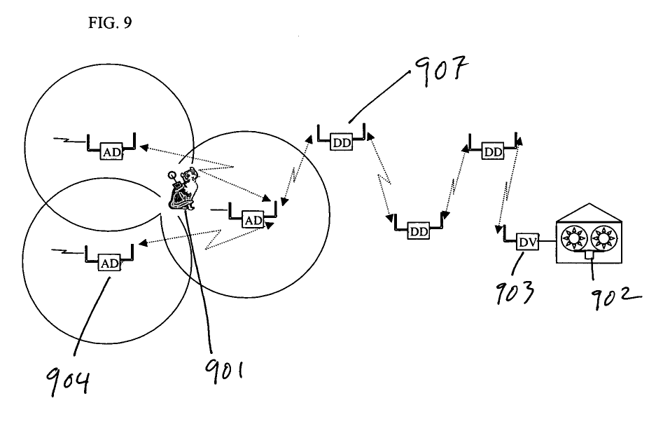

FIG. 9 shows an example of a system of transmitting data from a remote monitoring device 901 to a base station 902 having a receiver 903 using a wireless LAN 907. In this embodiment, each ground repeater 904 is within range of another ground repeater 904, allowing the ground repeaters 904 to communicate over a wireless LAN 907. The LAN 907 shown in this embodiment has a data speed exceeding 300 kbits/second (and preferably a data speed of several Mbits/sec) to allow compressed video to be forwarded in real time. All ground repeaters 904 are able to obtain signal strength information about all other repeaters via regular interrogation across the network 907 (such as TCP/IP) so no centralized control is needed to determine which ground repeater 904 should transmit as the remote monitoring device moves. Video is streamed back to the base station 902 across the network. Because the data sent is digital, there is little or no signal degradation due to the multiple reception and transmission through the various repeaters. This embodiment is preferable in terrain that has no suitable high point to place a Remote Repeater.

In FIGS. 4-9 the data transmitted from the remote monitoring device is shown to be analog data. According to alternate embodiments of the present invention, the data transmitted from the remote monitoring device is transmitted via a digital signal.

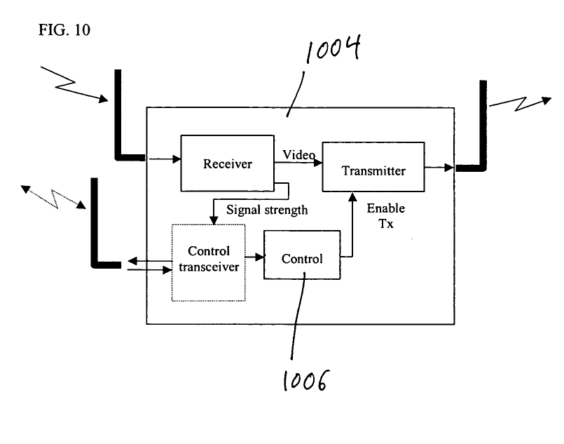

FIG. 10 shows an example of a typical ground repeater 1004 having a controller 1006, according to various embodiments of the present invention. Each ground repeater 1006 has at least: a receiver set to the frequency of transmission of the remote monitoring device and a transmitter, having a different frequency, which is activated by a control signal. The control signal can be set to enable the transmitter if the received signal strength exceeds a preset threshold, or it can be set to change state in response to a command from a control unit which receives a command to transmit from a remote repeater. In one embodiment, the transmission antenna is a highly directional yagi which can take advantage of line-of-sight communications with the remote repeater in order to reduce transmitter power and hence extend battery life.

According to an embodiment of the present invention, the receiver frequency can be tuned via a remote command to the control unit. This means that if the remote monitoring device was replaced at some point with a similar unit transmitting on a different frequency, it would not be necessary to visit every repeater to manually reset the receive frequency. The ability to retune the receivers in the various repeaters also allows one system to be used to monitor multiple remote monitoring devices in the same area without having to place redundant equipment in fragile ecosystems, thereby reducing human impact on the environment.

According to an embodiment of the present invention, if the remote monitoring device is detached from the subject animal, a portable repeater with a directional antenna and/or a signal strength indicator is used to find and locate the device.

According to an embodiment of the present invention, the remote repeater is similar in design to the ground repeaters, except that the receiver is tuned to the transmit frequency of the ground repeaters. Also, the transmitter power may be greater.

According to an embodiment of the present invention, charging facilities such as solar panels or wind-generators are used at the repeater sites to reduce the number of maintenance trips and thereby minimize human impact on the enviroment.

According to an embodiment of the present invention, directional yagi antennas are used on the receivers and/or transmitters.

According to an embodiment of the present invention, the data can be relayed from the remote monitoring device to a base station via a satellite.

According to an embodiment of the present invention, the camera includes a self steadying device to regulate the “bouncing” of the camera due to the movement of the subject animal.

According to an embodiment of the present invention, the camera includes a lens cleaning system to ensure that video capability is not lost due to a dirty lens.

1. A system, comprising:
a securing device having a release mechanism;
a data acquisition unit attached to the securing device, the unit configured to collect audio, video, and/or telemetry data;
a data transmission unit for receiving data from the data acquisition unit and transmitting the data;
a battery for providing power to at least the data acquisition unit and data transmission unit.

2. The system of claim 1 wherein the securing device includes a transceiver for receiving a remote signal.

3. The system of claim 1 wherein the securing device includes a remotely releasable hinge and the transceiver triggers the release of the hinge.

4. The securing device of claim 1 wherein the data transmission unit transmits a signal at a frequency of about 450 mhz.

5. The securing device of claim 1 wherein the data acquisition unit and the battery pack are located at opposite sides of the securing device.

6. The securing device of claim 5 wherein the battery is heavier than the data acquisition unit.

7. The system of claim 1 comprising a receiver for receiving transmissions from the data transmission unit.

8. The system of claim 1 comprising at least one repeater for receiving and retransmitting a signal from the data transmission unit.
